(19) United States
(12) Patent Application Publication
(10) Pub. No.: US 2006/0041764 A1
(43) Pub. Date: Feb. 23, 2006

(54) Method for switching processor performance states

(75) Inventors: Robert Shih, Taipei (TW); Allan Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/135,105

(22) Filed: May 23, 2005

(30) Foreign Application Priority Data
Aug. 20, 2004 (TW) 93125112

(51) Int. Cl. G06F 1/26

(52) U.S. Cl. 713/300

(57) ABSTRACT

A method for switching processor performance states, implemented in a computer having a processor and a read-only memory (ROM). The processor includes a frequency field and a voltage field respectively for controlling working frequency and voltage thereof. First, the processor retrieves a frequency identification and a voltage identification from the ROM, bits of which respectively correspond one-to-one to bits of the frequency field and the voltage field, and bit numbers of which are respectively the same as the frequency field and the voltage field. Each bit of the frequency field and the voltage field is respectively filled with a new value corresponding one-to-one to the bit corresponding thereto of the frequency identification or the voltage identification.

### BACKGROUND

The invention relates to a computer, and in particular, to processor power management.

Processor power consumption can be managed by adjusting processor operating frequency and voltage. The Advanced Configuration and Power Interface (ACPI) specification 2.0 provides several methods for performing this task, such as _PCT (performance control), _PSS (Performance Supported States), and _PPC (Performance Present Capabilities).

In a conventional method, an operating system (OS) issues system management interrupts (SMI) and gives system control to a Basic Input/Output System (BIOS) for executing processor power management. The frequent SMIs, however, may cause computer instability and inefficiency.

In another conventional method, the BIOS provides processor performance state-specific control values for adjusting processor operating frequency and voltage. The OS does not grant system control to the BIOS. An ACPI driver of the OS passes the control values to the processor driver program. The processor driver program derives resultant control values from the original control values and performs processor performance transitions by writing the resultant control values to the performance control register of a processor. This may be time consuming, and comprise querying a plurality of tables using respective portions of the original control values as indices or keys, and combining located values as the resultant control values. The greater the derivation complexity, the more time that may be spent to transit processor performance states.

Hence, there is a need for a method capable of reducing the derivation duration.

### SUMMARY

Accordingly, some embodiments of invention provide a method for switching processor performance states, implemented in a computer comprising a processor and a read-only memory (ROM). The processor comprises a register including frequency field and a voltage field respectively for controlling processor operating frequency and voltage thereof. A frequency identification and a voltage identification are retrieved from the ROM, bits of which respectively correspond one-to-one to bits of the frequency field and the voltage field, and bit numbers of which are respectively the same as the frequency field and the voltage field. Each bit of the frequency field and the voltage field is respectively filled with a new value reflecting only the value of the bit corresponding thereto included in the frequency identification or the voltage identification.

Also disclosed is a computer, comprising a read-only memory (ROM) and a processor. The ROM stores a frequency identification and a voltage identification. The processor comprises a frequency field and a voltage field respectively for controlling processor operating frequency and voltage thereof, retrieves the frequency identification and the voltage identification from the ROM, bits of which respectively correspond one-to-one to bits of the frequency field and the voltage field. Bit numbers of which are respectively the same as the frequency field and the voltage field, respectively fill each bit of the frequency field and the voltage field with a new value reflecting only the value of the bit corresponding thereto included in the frequency identification or the voltage identification.

### DESCRIPTION OF THE DRAWINGS

Some embodiments of the invention can be more fully understood by reading the subsequent detailed description and examples with references made to the accompanying drawings, wherein:

FIG. 1 is a block diagram of the configuration of a computer 10 according to an embodiment of the invention.

FIG. 2 is a flowchart of recording processor performance state-specific control values to a ROM according to an embodiment of the invention;

FIG. 3 is a schematic diagram showing a frequency identification, a voltage identification, a frequency field, a voltage field, and relationships R.

FIG. 4 is a flowchart of switching performance states of processor 1 according to an embodiment of the invention.

### DETAILED DESCRIPTION

Methods for simplifying processor performance state transition and a computers utilizing the same are provided.

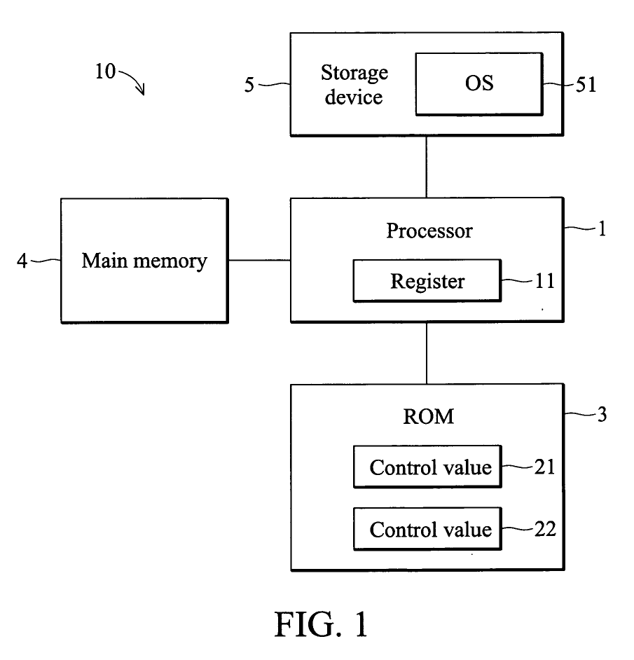

In FIG. 1, processor 1 is coupled to read-only memory (ROM) 3, main memory 4, and storage device 5 storing an operating system (OS) 51. Processor 1 comprises performance control register 11, such as a mode register set (MRS).

Register 11 comprises two respective sets of bits for adjusting operating frequency and voltage of processor 1, referred to as a frequency field and a voltage field respectively, and bits for controlling whether the processor operating frequency and voltage is adjustable. For example, register 11 comprises 32 bits, five of which form the frequency field and other five form the voltage field. The bit number of the frequency field and the voltage field may vary with specification of processors.

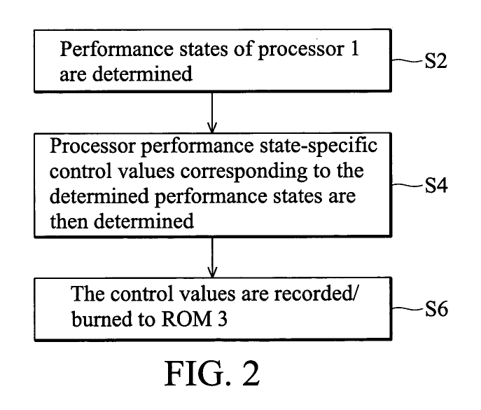

FIG. 2 is a flowchart of recording processor performance state-specific control values to ROM 3 according to an embodiment of the invention. First, a plurality of performance states of processor 1 are determined based on operating frequency and voltage specification of processor 1 and computer 10 (step S2), comprising, but not limited to, specification of voltage regulator modules thereof. A plurality of processor performance state-specific control values corresponding to the determined performance states are then determined (step S4), such as control value 21. For example, control value 21 “00000000111101101100000000000000” corresponds a first performance state with operating frequency 500 MHz and operating voltage 2.5 V, and control value 22 “00000000100011000100000000000000” corresponds a second performance state with an operating frequency of 1000 MHz and an operating voltage of 5 V. Note that the control values correspond one-to-one to the performance states. In other words, the number of control values equals the number of performance states, and different control values correspond to different performance states. The control values comprising control values 21 and 22 are recorded/burned to ROM 3 (step S6) which may be combined with a BIOS.

Each of the control values comprises two respective sets of bits corresponding to operating frequency and voltage statuses of processor 1, referred to as a frequency identification and a voltage identification respectively. In some embodiments of the invention, bits of each frequency identification correspond one-to-one to bits of the frequency field, bits of each voltage identification correspond one-to-one to bits of the voltage field, each bit value of a frequency identification corresponds one-to-one to the value of the corresponding bit thereof in the frequency field, and each bit value of a voltage identification corresponds one-to-one to the value of the corresponding bit thereof in the voltage field.

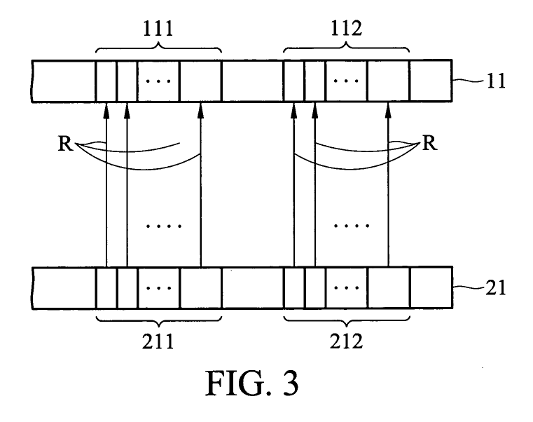

For example, in FIG. 3, the bit number of frequency field 111 equals the bit number of frequency identification 211, and bit number of voltage field 112 equals to the bit number of voltage identification 212. Every bit of frequency field 111 corresponds to a bit of frequency identification 211, and different bits of frequency field 111 correspond to different bits of frequency identification 211. Similarly, every bit of voltage field 112 corresponds to a bit of voltage identification 212, and different bits of voltage field 112 correspond to different bits of voltage identification 212.

In FIG. 3, each bit value of frequency identification 211 and voltage identification 212 has a relationship R to a new value of the corresponding bit thereof. A relationship R represents the one-to-one correspondence between a bit value of frequency identification 211 and a new bit value of frequency field 111 or between a bit value of voltage identification 212 and a new bit value of voltage field 112. Relationship R may comprise the same or different one-to-one correspondence, such as equal relation, inversion, and exclusive OR operation. If a bit value corresponds one-to-one to the value of the corresponding bit thereof, the number (such as 2) of probable values (such as “0” and “1”) of the bit equals the number (such as 2) of probable values (such as “0” and “1”) of the corresponding bit, and different bit values correspond to different values of the corresponding bit.

For example, if the relationship R is an equal relation, the new value of each bit of frequency field 111 and voltage field 112 equals the value of the corresponding bit thereof included in frequency identification 211 or voltage identification 212. For example, when a bit value of frequency identification 211 is “1”, the new value of the corresponding bit thereof included in frequency field 111 is also “1”. When a bit value of frequency identification 211 is “0”, the new value of the corresponding bit thereof included in frequency field 111 is also “0”.

For example, if the relationships R are inverted, new value of each bit of frequency field 111 and voltage field 112 is generated from the inversion of the value of the corresponding bit thereof included in frequency identification 211 or voltage identification 212.

Additionally, new bit values of frequency field 111 and voltage field 112 may be generated from exclusive OR operations of different constant and the values of the corresponding bits thereof included in frequency identification 211 or voltage identification 212. Thus, the relationships R may comprise different exclusive OR operations. The relationships R are assumed as an equal relation in the following description.

The relative order of bits within frequency identification 211 and voltage identification 212 may be the same as corresponding bits thereof within frequency field 111 and voltage field 112.

The absolute order of frequency identification 211 and voltage identification 212 within control value 21 may match the absolute order of frequency field 111 and voltage field 112 within register 11.

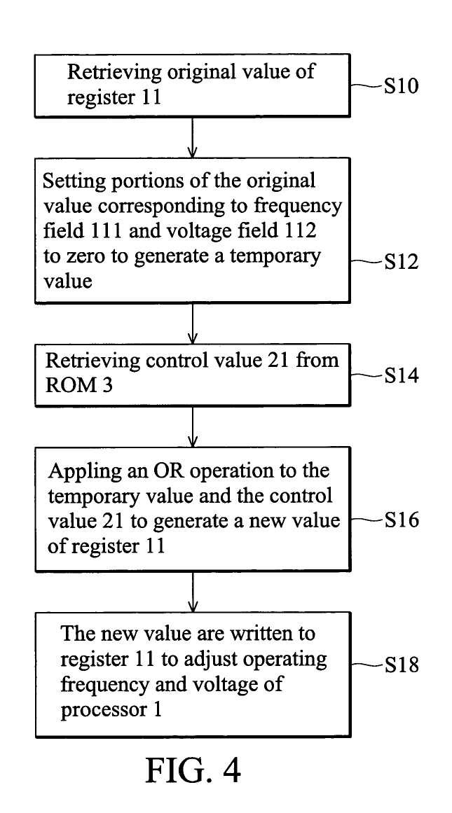

FIG. 4 is a flowchart of switching performance states of processor 1 according to an embodiment of the invention, which may conform to the methods provided by ACPI specification, such as _PSS indicating processor performance states supported by computer 10. The _PSS method comprises acquiring control values subsequently written to register 11 and status values allowing verification of performance status register of processor 1 after performance transition. The control values and status values input to the _PSS method are described latter.

For example, when processor 1 executes OS 51 and determines that computer 10 requires performance state transition, steps in FIG. 4 which may be implemented by driver programs of OS 51 are performed. Relationships R are defined and included in OS 51. Processor 1 switches performance states thereof by filling each bit of frequency field 111 and voltage field 112 with a new value according to relationships R and the corresponding bit value thereof included in frequency identification 211 or voltage identification 212.

For example, a register comprises 32 bits the least significant bit of which is referred as the first bit. Frequency field 111 and voltage field 112 comprise 20^{th} to 24^{th} bits and 15^{th} to 19^{th} bits respectively. Frequency identification 211 and voltage identification 212 comprise 20^{th} to 24^{th} bits and 15^{th} to 19^{th} bits of control value 21 respectively, wherein the least significant bit thereof is referred as the first bit.

In an example of relationships R comprising an equal relation, processor 1 retrieves original value of register 11 (step S10) and zeroes portions thereof corresponding to frequency field 111 and voltage field 112 to generate a temporary value from the original value (step S12). Processor 1 retrieves control values, such as control value 21 (step S14), and applies an OR operation to the temporary value and the control value to generate a new value of register 11 (step S16). The new value may be adopted as the control value and status value of the _PSS method and written to register 11 to adjust operating frequency and voltage of processor 1 (step S18). The previously described steps are illustrated in the following.

TABLE 1

| | | Bit order | | | |
|---|---|---|---|---|---|
| | | 25˜32 | 20˜24 | 15˜19 | 1˜14 |
| R1 | Original value | 00001001 | 10111 | 01111 | 01001100111000 |
| R2 | Temporal value | 00001001 | 00000 | 00000 | 01001100111000 |
| R3 | Control value 21 | 00000000 | 11110 | 11011 | 00000000000000 |
| R4 | New value | 00001001 | 11110 | 11011 | 01001100111000 |

For example, relationships R comprise equal relation. The original value of register 11 and control value 21 are shown in rows R1 and R3 of table 1 respectively. Values of frequency field 111 and voltage field 112 are replaced with frequency identification 211 and voltage identification 212 according to the relationships R, i.e. equal relation, respectively. Specifically, portions of the original value corresponding to frequency field 111 and voltage field 112 are zeroed to generate a temporary value as shown in row R2 (step S12). An OR operation is applied to the temporal value and the control value 21 to generate a new value of register 11 as shown in R4 (step S16). The new value is written to register 11 to adjust processor 1 to operating frequency 500 MHz and voltage 2.5 V (step S18). Similarly, when necessary, processor 1 may be adjusted to operating frequency 1 GHz and voltage 5 V according to control value 22.

The following table 2 shows parameters of an example where the relationships R comprise inversion.

TABLE 2

| | | Bit order | | | |
|---|---|---|---|---|---|
| | | 25˜32 | 20˜24 | 15˜19 | 1˜14 |
| R5 | Original value | 00001001 | 10111 | 01111 | 01001100111000 |
| R6 | Control value | 11111111 | 00001 | 00100 | 11111111111111 |
| R7 | Inverted value | 00000000 | 11110 | 11011 | 00000000000000 |
| R8 | New value | 00001001 | 11110 | 11011 | 01001100111000 |

The original value of register 11 and a control value are shown in rows R5 and R6 of table 1 respectively. Values of frequency field 111 and voltage field 112 are replaced with inverted frequency identification (20^{th}˜24^{th} bits) and voltage identification (15^{th}˜19^{th} bits) of the control value according to the relationships R, i.e. inversion, respectively. Specifically, the inverted value of the control value is generated as shown in R7, the same as control value 21. The new value of register 11 is generated as shown in R8 in the procedure as described in the previous example. The new value is written to register 11 to adjust processor 1 to operating frequency 500 MHz and voltage 2.5 V.

The following table 3 shows parameters of an example where the relationships R comprise exclusive OR (XOR) operations.

TABLE 3

| | | Bit order | | | |
|---|---|---|---|---|---|
| | | 25˜32 | 20˜24 | 15˜19 | 1˜14 |
| R9 | Original value | 00001001 | 10111 | 01111 | 01001100111000 |
| R10 | Control value | 11111111 | 11110 | 00100 | 11111111111111 |
| R11 | constant | 11111111 | 00000 | 11111 | 11111111111111 |
| R12 | Result of XOR | 00000000 | 11110 | 11011 | 00000000000000 |
| R13 | New value | 00001001 | 11110 | 11011 | 01001100111000 |

The original value of register 11 and a control value are shown in rows R9 and R10 of table 1 respectively. The result of an exclusive OR operation applied to the control value and a constant (in R11) is generated as shown in R12. Values of frequency field 111 and voltage field 112 are replaced with bits of the result corresponding to frequency identification (20^{th}˜24^{th} bits) and voltage identification (15^{th}˜19^{th} bits) respectively. The new value of register 11 is generated as shown in R13 in the procedure as described in the previous example. The new value is written to register 11 to adjust processor 1 to operating frequency 500 MHz and voltage 2.5 V.

Hence, generation of new values of frequency field 111 and voltage field 112 does not require parsing of the control values, used to query tables, or arranged with other complex algorithms. Each bit value of frequency field 111 and voltage field 112 reflects the corresponding bit value thereof included in frequency identification 211 or voltage identification 212. Thus, in switching performance states of processor 1, signal control value corresponds to only one new value of frequency field 111 and voltage field 112 and only one operating frequency and voltage status of processor 1.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for switching processor performance states, implemented in a computer comprising a processor and a read-only memory (ROM), wherein the processor comprises a frequency field and a voltage field respectively for controlling operating frequency and voltage thereof, comprising:
retrieving a frequency identification and a voltage identification from the ROM, bits of the frequency identification and the voltage identification respectively correspond to bits of the frequency field and the voltage field, and bit numbers of which are respectively the same as the frequency field and the voltage field; and
respectively filling each bit of the frequency field and the voltage field with a new value reflecting only the bit corresponding thereto included in the frequency identification and the voltage identification.

2. The method as claimed in claim 1, before filling each bit of the frequency field and the voltage field with a new value, further comprising:
retrieving original values of the frequency field and the voltage field; and
generating the new values to replace the original values.

3. The method as claimed in claim 2, wherein the new value are written into a register to switch the processor to a first frequency status and a first voltage status.

4. The method as claimed in claim 2, wherein an relative order of bits within the frequency identification and the voltage identification match the relative order of corresponding bits thereof within the frequency field and the voltage field.

5. The method as claimed in claim 4, wherein a control value comprises the frequency identification and the voltage identification, an absolute order of the frequency identification and the voltage identification within the control value match the absolute order of the frequency field and the voltage field within the register, and the length of the control value equals the length of the register.

6. The method as claimed in claim 1, wherein each new value is generated from the value of each bit corresponding thereto of the frequency field and the voltage field by binary operation.

7. The method as claimed in claim 1, wherein the new values of bits of the frequency field and the voltage field equal to the values of bits corresponding thereto.

8. The method as claimed in claim 1, further comprising storing control values in the ROM, respectively corresponding to predetermined performance states to which the processor can be switched, wherein a control value comprises the frequency identification and the voltage identification.

9. A computer, comprising:
a read-only memory (ROM) storing a frequency identification and a voltage identification;
a processor comprising a frequency field and a voltage field for controlling an operating frequency and an operating voltage thereof respectively, retrieving the frequency identification and the voltage identification from the ROM, bits of the frequency identification and the voltage identification respectively correspond to bits of the frequency field and the voltage field, and bit numbers of which are respectively the same as the frequency field and the voltage field, and respectively filling each bit of the frequency field and the voltage field with a new value only reflecting the bit corresponding thereto included in the frequency identification and the voltage identification.

10. The computer as claimed in claim 9, wherein before filling each bit of the frequency field and the voltage field with a new value, the processor retrieves original values of the frequency field and the voltage field and generates the new values to replace the original values.

11. The computer as claimed in claim 10, wherein the processor writes the generated new value to the register to switch the processor to a first frequency status and a first voltage status.

12. The computer as claimed in claim 10, wherein an relative order of bits within the frequency identification and the voltage identification match the relative order of corresponding bits thereof within the frequency field and the voltage field.

13. The computer as claimed in claim 12, wherein a control value comprises the frequency identification and the voltage identification, an absolute order of the frequency identification and the voltage identification within a control value match the absolute order of the frequency field and the voltage field within the register, and the length of the control value equals the length of the register.

14. The computer as claimed in claim 9, wherein each new value is generated from the value of each bit corresponding thereto of the frequency field and the voltage field by binary operation.

15. The computer as claimed in claim 9, wherein the new values of bits of the frequency field and the voltage field equal to the values of bits corresponding thereto.

16. The computer as claimed in claim 9, wherein the ROM stores a plurality of control values corresponding to a plurality of predetermined performance states to which the processor can be switched, and one of the control values comprises the frequency identification and the voltage identification.
